(19) United States
(12) Patent Application Publication
(10) Pub. No.: US 2023/0044593 A1
(43) Pub. Date: Feb. 9, 2023

(54) PIPETTE FOR USE WITH A PIPETTE TIP

(71) Applicant: Eppendorf SE, Hamburg (DE)

(72) Inventors: Florian Tesch, Hamburg (DE); Julian Bikmohammadi, Hamburg (DE); Peter Molitor, Hamburg (DE); Jens Wilmer, Ahrensburg (DE); Burkhardt Reichmuth, Hamburg (DE)

(73) Assignee: Eppendorf SE, Hamburg (DE)

(21) Appl. No.: 17/884,156

(22) Filed: Aug. 9, 2022

(30) Foreign Application Priority Data
Aug. 9, 2021 (EP) 21190341.4

(51) Int. Cl. B01L 3/02

(52) U.S. Cl. CPC B01L 3/0224; B01L 2200/0605; B01L 2400/0478

(57) ABSTRACT

A pipette for use with a pipette tip includes a chassis. An apparatus is coupled to the chassis and is configured to detachably hold at least one pipette tip. A drive apparatus is coupled to the chassis and is configured to displace a displacement element to suck liquid specimens into the pipette tip and eject the specimens from the pipette tip. A tubular pipette housing is configured to surround and connect to the chassis. The longitudinal direction of the chassis is aligned in the longitudinal direction of the pipette housing. The chassis includes multiple chassis elements which are arranged behind one another and are connected to one another. The apparatus for detachably holding at least one pipette tip and the drive apparatus are connected to one or more of the multiple chassis elements.

### CROSS REFERENCE TO RELATED INVENTION

This application is based upon and claims priority to, under relevant sections of 35 U.S.C. § 119, European Patent Application No. 21190341.4, filed Aug. 9, 2021, the entire contents of which are hereby incorporated by reference.

### TECHNOLOGICAL FIELD

The disclosure relates to a pipette for use with a pipette tip.

### BACKGROUND

Pipettes are utilized in particular in scientific and industrial laboratories in medical, molecular biological and pharmaceutical areas of application for dosing selected volumes of liquids. The liquids can in particular be homogeneous (single-phase) liquids consisting of a single liquid component, or a homogeneous mixture of multiple liquid components (solutions). Furthermore, the liquids can be heterogeneous (multiphase) mixtures of a liquid with another liquid (emulsions), or a solid (suspension).

Known pipettes have a stem-shaped pipette housing with a spigot (attachment) on the lower end for clamp-fitting a pipette tip. The spigot is frequently a conical, cylindrical or sectionally conical and cylindrical projection, and is also referred to as a “working cone”. A pipette tip is a small hollow tube with a tip opening on the lower end and a mounting opening on the upper end, with which the pipette tip can be clamped to the spigot. The liquid is drawn into the pipette tip and discharged therefrom. Pipette tips without an integrated piston and pipette tips with an integrated piston are known. The drawing and discharging of the liquid are controlled by means of the pipette. Fixed-volume pipettes serve to pipette constant volumes. With variable pipettes, the volume to be dosed is adjustable. To adjust the volume, the stroke of a drive apparatus can be adjusted by means of an adjusting apparatus. A mechanical counter which is coupled to the adjusting apparatus serves to display the adjusted volume. After use, the pipette tip is detached from the attachment, and can be exchanged for a fresh pipette tip. As a result, cross-contaminations in subsequent pipetting can be avoided. Pipettes mostly have an ejection apparatus which makes it possible to eject pipette tips by actuating a knob without touching the pipette tips.

Air cushion pipettes mostly have a piston-cylinder arrangement in the pipette housing, which is connected by a channel to a through-hole in the spigot. Pipette tips for air cushion pipettes (air cushion pipette tips) do not have an integrated piston. By displacing the piston by means of the drive apparatus in the cylinder, an air cushion is moved in order to suck liquid into a pipette tip clamped onto the spigot and to eject it therefrom. A disadvantage with air cushion pipettes is that dosing errors occur due to changes in the length of the air cushion caused by the weight of the sucked-in liquid, and changes in temperature, air pressure and humidity. Contamination of the pipette by aerosols can also be problematic.

Positive displacement pipettes are used with pipette tips with integrated pistons (positive displacement pipette tips). This type of pipette has a spigot for fastening the pipette tip, and a drive apparatus that can be coupled to the integrated piston (tip piston) for displacing the piston. The piston comes directly into contact with the liquid so that the disadvantageous effects of an air cushion do not exist. Positive displacement pipettes are in particular suitable for dosing liquids with a high vapor pressure, high viscosity or high density, and for applications in molecular biology in which freedom from aerosols is important in order to avoid contamination.

Pipettes are, as a general rule, hand-held devices which can be held and operated by the user with only one hand during application. Manually driven pipettes in which the drive apparatus is driven by means of muscle power are known. Furthermore, pipettes driven by an electric motor are known, in which the drive apparatus comprises an electric motor as well as control electronics for controlling the electric motor.

Air cushion or positive displacement pipette tips for single use or reuse consist of plastic or of glass.

An air cushion pipette for use with an air cushion pipette tip is described in EP 2 633 915 B1, and a positive displacement pipette for use with a positive displacement pipette tip is described in EP 3 560 596 A1.

In the case of conventional pipettes, the spigot for clamp-fitting the pipette tip, components of the drive apparatus and, if applicable, further components are held directly on the pipette housing. Consequently, the pipette housing serves as a support structure for the components of the pipette. As a consequence, all of the forces which arise during pipetting are transferred to various locations on the housing. The consequence of this is that the housing has to have an elaborate design, which makes an injection molding tool for producing the housing complicated and expensive. Moreover, all of the components of the pipette have to be assembled in or on the housing, so that the assembly overall is elaborate. Another consequence is that the selection of materials for the housing is limited, as the material must be suitable for absorbing the resulting forces. In particular, no soft housing materials can be used and the application advantages thereof cannot be utilized. In addition, there can be problems with autoclaving if the components of the pipette are fastened to different locations on the housing.

EP 2 578 317 B1 and U.S. Pat. No. 9,180,446 describe a manual dosing device with a support structure, which has means for detachably holding a syringe or a pipette tip on the lower end and in which drive means for a piston for displacing a fluid in the syringe or pipette tip are fastened to the support structure above the means for detachably holding the syringe or pipette tip. The support structure is formed by an elongated frame having parallel, spaced longitudinal members in such a way that forces occurring on actuating the drive means are introduced into the frame. The housing envelops the drive means and the frame and is preferably only assembled on the frame at a few points in order to relieve stress on the housing. The longitudinal members of different frame parts have interlocking connecting structures, and fastening means which connect these connecting structures to one another are provided. An exemplary embodiment of a dispenser is described in detail. This is a positive displacement system for use with a syringe, in which the cylinder of the syringe is fixed and, in order to draw up liquid, the piston is pulled out of the cylinder a bit by means of a lifting lever. To deliver the absorbed liquid, the piston is pushed further into the cylinder by means of a toothed rod ratchet apparatus with an adjustable step size. Compared to pipette tips with or without an integrated piston, the syringes mostly have a significantly larger volume. A pipette, in which means for detachably holding a pipette tip are arranged on the lower end of the elongated frame with parallel, spaced longitudinal members, and a cylinder having a piston which can be displaced therein and drive means for the piston are fastened above the means for detachably holding the pipette tip, is also described.

EP 3 399 215 A1 describes an electronic hand dispenser having a spindle drive which comprises a support structure, to which a guide element for the drive spindle is fixedly connected and to which an electric drive motor for the drive spindle is fastened. The support structure is a housing and/or a frame (chassis) and/or a support and consists of a single component or of multiple components.

DE 11 2016 006 174 T5 describes a lower part of a multichannel pipette having a unit housing configured as a double-housing design having a front-face-side and a rear-face-side housing, on which attachments for pipette tips are held. An ejecting device cover having a front-face-side cover and a rear-face-side cover receives the unit housing.

EP 1 015 110 B1 describes a pipette having a frame made of rigid plastic, which is embedded in a cushioned membrane that rests comfortably in the palm of the user. The frame is tubular and components of a drive apparatus, a counter and a gear mechanism for transferring the adjustment of a volume adjusting ring to the counter are arranged behind one another and partially interlocking in the frame. The volume adjusting ring is mounted between a lower part of the pipette, in which a cylinder having a piston displaceable therein is arranged, and an upper part of the pipette comprising the membrane as well as the frame embedded therein. The assembly of the pipette is elaborate.

EP 3 159 397 B1 describes a pipetting head for an automatic pipettor, which has a cylinder with a piston that can be displaced therein as well as a spindle drive having an electric drive motor for the piston on a first frame. On a second frame, which can be displaced by means of a spindle drive with respect to the first frame, a tip ejector is arranged in order to squeeze off a pipette tip mounted on the cylinder.

Against this backdrop, the object which forms the basis of the invention is to provide a pipette for use with a pipette tip which facilitates the assembly, which catches the forces occurring during use and makes possible a freer design of the pipette housing.

### BRIEF SUMMARY OF THE INVENTION

The object is achieved by a pipette having the features of claim 1. Advantageous embodiments of the pipette are indicated in subclaims.

The pipette according to the invention for use with a pipette tip comprises:

an oblong chassis;

components, connected to the chassis, of an apparatus for detachably holding at least one pipette tip and of a drive apparatus for displacing a displacement element for sucking liquid specimens into the pipette tip and ejecting the specimens from the pipette tip;

a tubular pipette housing which surrounds the chassis, wherein the longitudinal direction of the chassis is aligned in the longitudinal direction of the pipette housing, and which is connected to the chassis;

characterized in that

the chassis has multiple tubular chassis elements which are arranged behind one another and connected to one another; and

the components of the apparatus for detachably holding at least one pipette tip and of the drive apparatus are connected to various chassis elements.

In the case of the pipette according to the invention, the chassis has multiple tubular chassis elements which are connected to one another. The chassis is also referred to as a frame, and the chassis elements are also referred to as frame elements. The chassis elements make it possible to gradually assemble assemblies consisting of chassis elements having components connected thereto, so that the components are held on the chassis elements in such a way that they are prevented from being lost. The components can be all of the components relevant to the function of the pipette. The components relevant to the function of the pipette comprise at least the components of the apparatus for detachably holding the pipette tip and the components of the drive apparatus. Optionally, there are additional components of other apparatuses, in particular components of a display apparatus for displaying an adjusted dosing volume and/or an ejection apparatus for ejecting at least one pipette tip from a spigot, onto which it is clamped. The pipette housing is connected to the chassis.

A major advantage is that all of the forces can be absorbed by the chassis by the connection of the components to the chassis elements. Here, recourse can be had to high-strength materials for the chassis elements, since no materials have to be used for the chassis, which are desired for the housing in order to realize a specific design or haptic properties of the pipette. As a consequence, materials which were not considered for conventional pipettes can be used for the housing, without having to relinquish the required strength for absorbing the forces. The fact that the chassis element can be configured from corresponding high-strength materials means that a reproducible accuracy of the travel distances of the drive apparatus can also be guaranteed. A further advantage is that the components can be preassembled separately on the different chassis elements, which facilitates the assembly as a result. In order to further facilitate the assembly, the components can be preassembled on the chassis elements in such a way that the loss thereof is prevented. An assembly (also referred to as a “preliminary assembly” or “module”) can be formed from one or more components and, in each case, one chassis element, which can be independently tested during assembly, which has advantages for quality assurance. The complete or partial dismantling of the pipette for maintenance or repair purposes is also facilitated by the construction of the pipette from chassis elements and components connected thereto. Assemblies can be maintained and repaired independently. Furthermore, a chassis element for receiving a lower part can be configured, as a result of which a holding ring which, until now, has had to be fastened separately in the housing can be replaced. Due to the modular construction, different pipettes can be constructed by means of similar assembly steps and functional assemblies can be varied by exchanging or omitting individual components or assemblies made up of chassis elements and components. In addition, many identical parts can be used for various pipettes. A further advantage is that the development outlay for further pipettes is reduced, since the basic framework of the pipette can at least partially be reused.

The fact that the chassis comprises multiple tubular chassis elements makes a particularly stable execution of the chassis possible, which withstands relatively high forces with a relatively low material outlay. Moreover, the tubular chassis elements favor particularly simple and stable connections of the tubular chassis elements to one another. A further advantage is that the tubular chassis elements are particularly well suited to receiving the various tubular or rod-shaped components of the pipette in a space-saving manner. Moreover, it is advantageous that the components can be accommodated in the tubular chassis elements in such a way that they are protected. Finally, the chassis with the tubular chassis elements and the components connected thereto can be simply inserted into the tubular pipette housing, for example by being pushed in through a lower or upper opening of a one-piece tubular pipette housing, by pushing parts of the tubular pipette housing over the ends of the chassis or by inserting the chassis into a shell of a tubular pipette housing consisting of multiple shells. This also facilitates the dismantling of the pipette.

Tubular chassis elements within the meaning of the present application are circular cylinders, cylinders having a different cross-section to a circular cross-section and other oblong hollow bodies, wherein the length of the hollow body can be greater, less than or equal to the maximum dimensions of the hollow body perpendicular to the longitudinal axis of the hollow body. The tubular chassis elements can also be portions or segments of a cylinder or of another oblong hollow body. Furthermore, the tubular chassis elements can have inwardly protruding structures and/or outwardly protruding structures with respect to their surfaces, as a result of which they deviate from the form of a cylinder or of a simple oblong hollow body. The tubular chassis elements can be chassis elements which have at least one tubular and one non-tubular portion behind one another in the longitudinal direction, wherein the tubular portion is connected to the non-tubular portion. For example, the tubular chassis element can have multiple annular or ring-segment-shaped portions which are connected to one another via one or more rod-shaped portions, or only a single annular or ring-segment-shaped portion which is connected to one or more rod-shaped portions. An annular or ring-segment-shaped portion of the chassis element is preferably connected to another tubular chassis element.

According to an embodiment of the invention, all of the chassis elements are tubular. This makes possible a particularly stable chassis with a relatively low material outlay.

According to another embodiment, the chassis comprises, in addition to multiple tubular chassis elements, one or more non-tubular chassis elements. Non-tubular chassis elements include in particular chassis elements which are formed from one or more rods (e.g., having a rectangular profile, circular profile, cross profile, U-profile, C-profile, T-profile in each case with a full cross-section or hollow cross-section) or from one or more frames (e.g., formed from rods of the aforementioned type). The non-tubular chassis elements can furthermore include those chassis elements which are formed by one or more plates. The non-tubular chassis elements can in particular bridge the range of distance between two tubular chassis elements or can be arranged on the upper or lower end of the chassis.

According to another embodiment, the chassis comprises precisely two or precisely three or precisely four tubular chassis elements.

According to another embodiment, at least one component of a drive apparatus for displacing a displacement element is connected to at least one chassis element and/or at least one component of a display apparatus for displaying an adjusted pipetting volume is connected to at least one chassis element and/or at least one component of an ejection apparatus for ejecting at least one pipette tip from a spigot is connected to at least one chassis element and/or at least one component of an apparatus for detachably holding at least one pipette tip is connected to at least one chassis element and/or at least one component of an apparatus for detachably holding the chassis elements in the pipette housing is connected to at least one chassis element. This makes the assembly and dismantling of the pipette even easier.

According to another embodiment, a first assembly comprises a chassis element and at least one component of the drive apparatus and/or a second assembly comprises a chassis element and at least one component of the display apparatus and/or a third assembly comprises a chassis element and at least one component of the ejection apparatus and/or a fourth assembly comprises a chassis element and at least one component of the apparatus for detachably holding at least one pipette tip and/or a fifth assembly comprises a chassis element and at least one component of the apparatus for detachably holding the chassis elements in the pipette housing.

According to another embodiment, the drive apparatus comprises a first subassembly made of multiple components, which is connected to at least one chassis element and/or the display apparatus comprises a second subassembly made of multiple components, which is connected to at least one chassis element and/or the ejection apparatus comprises a third subassembly made of multiple components, which is connected to at least one chassis element and/or the apparatus for detachably holding at least one pipette tip comprises a fourth subassembly made of multiple components, which is connected to at least one chassis element and/or the apparatus for detachably holding the chassis elements in the pipette housing comprises at least one fifth subassembly made of multiple components, which is connected to at least one chassis element. This makes it possible to preassemble at least one subassembly in a first preassembly step and to preassemble at least one subassembly with at least one chassis element in a second preassembly step and further facilitates the assembly and dismantling.

The preassembly of at least one subassembly can also be combined with the preassembly of at least one component on the same chassis element.

According to another embodiment, components of the drive apparatus (e.g., an actuating element, a threaded spindle, a spindle nut and a lifting rod) are connected to a first chassis element and/or components of the display apparatus (e.g. a counter and/or a transfer unit and/or a factory calibration apparatus) are connected to a second chassis element and/or components of the drive apparatus (e.g., an overstroke system and/or a customer calibration) and/or components of the ejection apparatus are connected to a third chassis element and/or at least one component of the apparatus for detachably holding at least one pipette tip (e.g., a tubular coupling element for a lower part) is connected to a fourth chassis element or configured as such. This is an advantageous embodiment of an air cushion pipette.

According to another embodiment, components of the drive apparatus (e.g., a threaded spindle and a spindle nut) and/or components of the display apparatus (e.g., of a counter) are connected to a first chassis element and/or components of the drive apparatus (e.g., an actuating element and/or a lifting rod and/or a switching device for switching the displacement of a lifting rod in various directions) and/or components of the ejection device (e.g., a rotating sleeve) are connected to a second chassis element and/or components of the drive apparatus (e.g., toothed rods and pinions for displacing a lifting rod) are connected to a third chassis element and/or components of the ejection apparatus (e.g., an ejection rod and/or a locking sleeve) and/or components of the apparatus for detachably holding at least one pipette tip (e.g., a spigot) are connected to a fourth chassis element. This is an advantageous embodiment of a positive displacement pipette.

According to another embodiment, the first chassis element is arranged above the second chassis element, the second chassis element is arranged above the third chassis element and the third chassis element is arranged above the fourth chassis element.

According to another embodiment, at least one component and/or at least one subassembly is/are arranged at least partially inside and/or on the side of a tubular chassis element connected thereto.

According to another embodiment of an air cushion pipette, the drive apparatus has a threaded spindle which engages in an internal thread of the first chassis element and can be adjusted in the longitudinal direction of the first chassis element. According to another embodiment, the drive apparatus has an adjusting sleeve which is rotatably mounted in the first chassis element and connected to the threaded spindle to rotate conjointly and such that they can be displaced in the longitudinal direction relative to one another, said adjusting sleeve having an adjusting knob protruding upward from the first chassis element. According to another embodiment, the drive apparatus has a catch sleeve arranged concentrically to the adjusting sleeve, which has an external circumferential toothing, the adjusting sleeve has two circumferential toothings of different diameters on the circumference and the drive apparatus has a transfer unit with pinions having different diameters, wherein by displacing the adjusting sleeve or the transmission from an upper into a lower position, various pinions of the transfer unit can be brought into engagement with the toothings of the adjusting sleeve and the catch sleeve and, as a result, different gear multiplications between the adjusting sleeve and catch sleeve can be adjusted. In this embodiment, the catch sleeve is also rotatably mounted in the first chassis element and the catch sleeve is connected to the threaded spindle to rotate conjointly and such that they can be displaced in the longitudinal direction relative to one another. According to another embodiment, the drive apparatus has a lifting rod running through a through-bore of the threaded spindle extended in the longitudinal direction, which can be displaced with at least one projection on the circumference until it contacts a first stop on the underside of the threaded spindle, forming the drive element below the projection and protruding from the first chassis element with an operating knob on the upper end. As a result, the essential components of a drive apparatus are connected to the first chassis element.

Details of a pipette having an adjustable conversion between the adjusting sleeve and the catch sleeve are described in European patent application EP 19 191 903.4. In this regard, reference is made to European patent application EP 19 191 903.4, the contents of which are hereby incorporated into this application.

According to another embodiment of an air cushion pipette, the second chassis element is held on the lower end of the first chassis element and a counter is held on holding apparatuses on the casing of the second chassis element and of the first chassis element. This simplifies the preassembly of the counter and its connection to the drive apparatus. According to another embodiment, the transfer unit is held on retaining apparatuses on the casing of the second chassis element and of the first chassis element.

According to another embodiment of an air cushion pipette, the third chassis element is connected to the lower end of the first chassis element and/or of the second chassis element and an overstroke system having a passage is arranged inside the third chassis element, through which passage the lifting rod extends downward, wherein, during a downward displacement, the lifting rod, after the projection hits a second stop on the top of the overstroke system, can be displaced further downward against the effect of an overstroke spring. This simplifies the preassembly of the overstroke system and the coupling thereof to the lifting rod.

According to another embodiment of an air cushion pipette, the fourth chassis element is a tubular coupling element and a lower part having a connecting spigot is inserted into the coupling element, wherein the lower part has at least one displacement element in a displacement chamber and a hollow spigot connected to the displacement chamber for detachably holding a pipette tip. A tubular coupling element on the lower end of the chassis is particularly well suited to coupling a spigot-shaped coupling element to the upper end of the lower part.

According to another embodiment of an air cushion pipette, the lower part has a drive rod coupled to the lower end of the lifting rod in the connecting spigot for coupling to the tubular coupling element, which drive rod is connected to at least one piston which is displaceably arranged in a cylinder, wherein the cylinder is arranged in the lower part and is connected on the lower end to a spigot for detachably holding a pipette tip protruding from the lower part. In this embodiment, the lower part can be connected via the connecting spigot to the chassis to form a structure which is particularly stable overall. The coupling of the lifting rod to the drive rod can be produced particularly easily. In the case of a multichannel pipette, the drive rod can protrude upward from a cross-member which is connected at the bottom to the piston rods of the piston of a plurality of piston-cylinder units, the cylinders of which are in each case connected to a hollow spigot for detachably holding a pipette tip. In the case of a single-channel pipette, the drive rod can simultaneously be the piston rod of a piston of a piston-cylinder unit, the cylinder of which is connected to a hollow spigot for detachably holding a pipette tip.

According to another embodiment, a lower part having only one channel or multiple channels is coupled via a connecting spigot to the coupling element. Each channel is formed by a piston arranged displaceably in a cylinder having a spigot on the lower end. A lower part having only one channel forms, together with the pipette, a single-channel pipette (on the only spigot of which a single pipette tip can be clamped in each case). A lower part having multiple channels forms a multichannel pipette, on the spigot of which multiple pipette tips can be clamped simultaneously.

According to another embodiment, multiple cylinders are held parallel to one another in a box-like lower part chassis which is connected at the top to the connecting spigot and forms a lower part housing. In this embodiment, the lower part is also provided with a chassis.

According to another embodiment of a positive displacement pipette, the first chassis element has adjusting apparatuses for adjusting the dosing volume with an adjusting knob for adjusting the dosing volume, which protrudes upward from the first chassis element and is rotatably mounted on the first chassis element, and a counter coupled to the adjusting apparatuses for adjusting the adjusted dosing volume. In the case of the positive displacement pipette, the adjusting apparatus and the counter can be advantageously arranged on the first chassis element.

According to another embodiment of a positive displacement pipette, a second chassis element rotatably supports a rotating sleeve on the casing and an actuating element for executing a dosing stroke and for ejecting a pipette tip from the spigot is arranged on the second chassis element. Both the dosing and the ejecting of a pipette tip can be controlled by means of the actuating element. Details of the rotating sleeve and of the actuating element are described in European patent application EP 19 150 808.4. In this regard, reference is made to European patent application EP 19 150 808.4, the contents of which are hereby incorporated into this application.

According to another embodiment of a positive displacement pipette, a switching apparatus is connected to the second chassis element, which switching apparatus is coupled to the actuating element in order to displace a piston lifting rod for displacing a tip piston in different directions during successive displacements of the actuating element by a specific stroke downward. Details of the switching apparatus are described in European patent application EP 20 181 406.8. In this regard, reference is made to European patent application EP 20 181 406.8, the contents of which are hereby incorporated into this application.

According to another embodiment, a third chassis element is connected to toothed rods, a lifting rod and a gear mechanism coupling the toothed rods to the lifting rod and has guides for a piston ejector and for apparatuses for adjusting a display sleeve. The toothed rods serve to displace the lifting rod in various directions and work together with the switching apparatus. By arranging the switching apparatus in the second chassis element and fastening and guiding the toothed rods to the third chassis element, the coupling between the toothed rods and the switching apparatus can be easily produced during the assembly. According to another embodiment, the gear mechanism has a multi-stage toothed rod with multiple parallel rows of teeth, another toothed rod fixedly connected to the lifting rod and two pinions having the same or different diameters, which are connected to a common shaft to rotate conjointly, wherein the one of the two pinions meshes with the teeth of a row of teeth of the multi-stage toothed rod and the other of the two pinions meshes with the teeth of the other toothed rod. By means of the multi-stage toothed rod, pipettes having different gear multiplications/gear reductions between the multi-stage toothed rod and the toothed rod fixedly connected to the lifting rod can be realized by using different gear sets. As a result, pipettes for pipette tips having various nominal volumes can be provided with the same size operating path for delivering the nominal volume. This assembly facilitates the realization of various pipette variants by inserting gear sets having different gear multiplications/gear reductions. Details of the toothed rods, the lifting rod and of the gear mechanism coupling these are described in European patent application EP 20 181 406.8. In this regard, reference is made to European patent application EP 20 181 406.3 (in particular pages 15 to 17 and 27 to 28), the contents of which are hereby incorporated into this application.

According to another embodiment, the fourth chassis element has a protruding spigot for clamp-fitting a pipette tip having an integrated piston on the lower end.

According to another embodiment, an ejection apparatus for ejecting pipette tips from the spigot is guided on the first chassis element and/or on the fourth chassis element. This makes possible a simple preassembly of the ejection apparatus. Details of the ejection apparatus and of the spigot are described in European patent application EP 19 150 847.2. In this regard, reference is made to European patent application EP 19 150 847.2, the contents of which are hereby incorporated into this application.

According to the following embodiments, both air cushion pipettes and positive displacement pipettes can be configured.

According to another embodiment, the adjacent chassis elements are connected to one another in at least one of the following ways: detachably, non-detachably or detachably to a limited extent (involving destroying connecting elements) and/or in a firmly bonded manner, positively or non-positively. The chassis elements are preferably detachably connected to one another. This results in a particularly simple, fixed and secure connection of the adjacent chassis elements to one another.

According to another embodiment, the components and/or the assemblies are connected to the chassis elements in at least one of the following ways: detachably, non-detachably or detachably to a limited extent (involving destroying connecting elements) and/or positively, non-positively or in a firmly bonded manner. The components and/or assemblies are preferably detachably connected to the chassis elements. This results in a particularly simple, fixed and secure connection of the components and/or assemblies to the chassis elements.

According to another embodiment, adjacent chassis elements have positioning elements which hold the adjacent chassis elements in a certain alignment or position relative to one another. According to another embodiment, the positioning elements comprise at least one pair of latching elements, wherein adjacent chassis elements each have one latching element of the pair, and the adjacent chassis elements can be held relative to one another by latching their latching elements to one another in a specific alignment or position. According to another embodiment, the positioning elements comprise at least one pair of magnetic components which are formed either by two magnets or by one magnet and one ferromagnetic component, wherein adjacent chassis elements each have one magnetic component of the pair.

According to another embodiment, at least one chassis element has at least one protruding position rib or position surface on the outside, with which the chassis element or multiple put-together chassis elements can be easily placed in a test gage in order to make it possible to carry out difficult dimensional inspections in the shortest possible time without much outlay. This also makes it possible to inspect assembly forces during production.

According to another embodiment, the pipette housing is connected to the chassis in at least one of the following ways and/or the lower part housing is connected to the lower part chassis in at least one of the following ways: detachably, non-detachably or detachably to a limited extent (involving destroying connecting elements) and/or positively, non-positively or in a firmly bonded manner. The pipette housing is preferably detachably connected to the chassis. As a result, a particularly fixed, simple and secure connection of the respective chassis to the respective housing is achieved, which avoids the introduction of high forces into the various housings.

According to another embodiment, the pipette housing is connected to one location of the chassis. According to a preferred embodiment, this location is multiple points or a surface on a circumferential, continuous line on the inner circumference of the pipette housing. According to another embodiment, the pipette housing is connected to the lower end of the chassis. According to another embodiment, the pipette housing is only connected to a single or to two adjacent chassis elements. This avoids forces acting on the chassis being transferred via the pipette housing. Furthermore, this has the advantage that a thermal expansion of the pipette housing does not have any repercussions on components which are relevant to the function of the pipette, which are held on the chassis elements.

According to another embodiment, the pipette housing is configured in such a way that the chassis, composed of all the chassis elements equipped with the respective components, can be inserted into the pipette housing. This simplifies the assembly of the pipette. Furthermore, this makes it possible to carry out tests, calibration and other adjustment work prior to the complete assembly before the chassis equipped with the components is installed in the pipette housing.

In the present application, the terms “upper” and “lower” as well as “vertically” and “horizontally” and terms derived therefrom such as, e.g., “above” and “below”, as well as “above one another” refer to an arrangement of the pipette in which the spigot is aligned vertically, and is located on the end of the pipette housing which points downward.

### BRIEF DESCRIPTION OF THE DRAWINGS

The invention is described in greater detail below with reference to the accompanying drawings of exemplary embodiments, wherein:

FIG. 1 shows an upper part of an air cushion pipette in a longitudinal section;

FIG. 2 shows chassis elements with components connected thereto of the same pipette in an exploded view;

FIG. 3 shows the same chassis elements in an exploded view;

FIG. 4 shows chassis elements from FIG. 3, joined together, in a side view;

FIG. 5 shows chassis elements connected to components from FIG. 2 partially joined together in a perspective view, obliquely from the side;

FIG. 6 shows chassis elements connected to components from FIG. 2, joined together, in a side view;

FIG. 7 shows chassis elements connected to components, joined together with a first exemplary embodiment of an ejection apparatus in a perspective view, obliquely from the side;

FIG. 8 shows chassis elements connected to components, joined together with a second exemplary embodiment of an ejection apparatus in a perspective view, obliquely from the side;

FIG. 9 shows a chassis element with an overstroke system of the same pipette in an exploded view, obliquely from below and from the side;

FIG. 10 shows a chassis element with a counter of the same pipette in a perspective view from the left side;

FIG. 11 shows a chassis element with a counter of the same pipette in a perspective view from the right side;

FIG. 12 shows a lower part of the same pipette without a lower part housing in a partially broken front view;

FIG. 13 shows a positive displacement pipette in a front view;

FIG. 14 shows the same positive displacement pipette in a side view along the longitudinal axis in a plane rotated by 90° with respect to FIG. 13;

FIG. 15 shows chassis elements of the same pipette equipped and preassembled with components in a perspective view, obliquely from below and from the side;

FIG. 16 shows the first chassis element of the same positive displacement pipette in a perspective view, obliquely from below and from the side;

FIG. 17 shows the same chassis element equipped with components in a perspective view, obliquely from below and from the side;

FIG. 18 shows a second chassis element from above of the same pipette in a perspective view from below and from the side;

FIG. 19 shows the same chassis element equipped with components in a perspective view from below and from the side;

FIG. 20 shows a third chassis element from above of the same pipette in a perspective view from below and from the side;

FIG. 21 shows the same chassis element equipped with components in a perspective view from below and from the side;

FIG. 22 shows the fourth chassis element from above of the same pipette in a perspective view from below and from the side;

FIG. 23 shows the same chassis element equipped with components in a perspective view from below and from the side;

FIG. 24 shows the coupling of the assembly from FIG. 22 to the counter from FIG. 16 in a perspective view, obliquely from below and from the side.

### DETAILED DESCRIPTION OF THE INVENTION

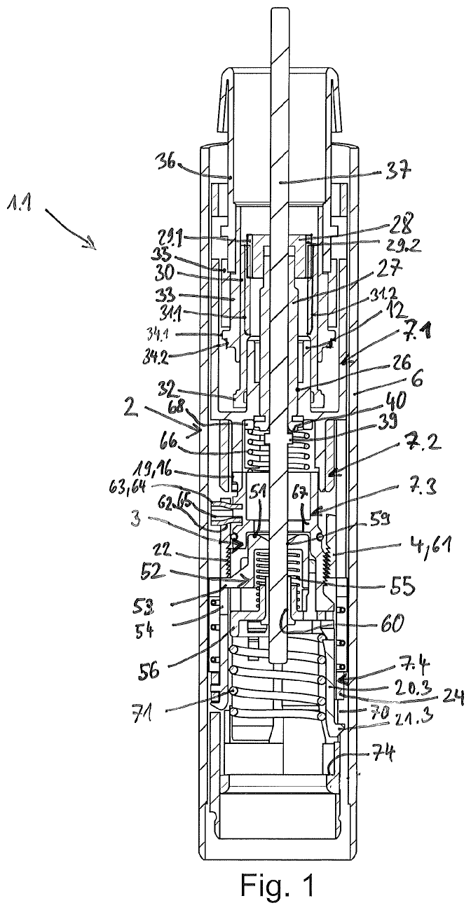

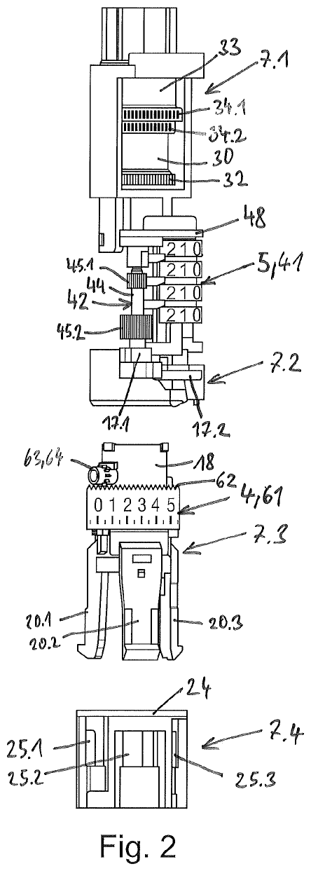

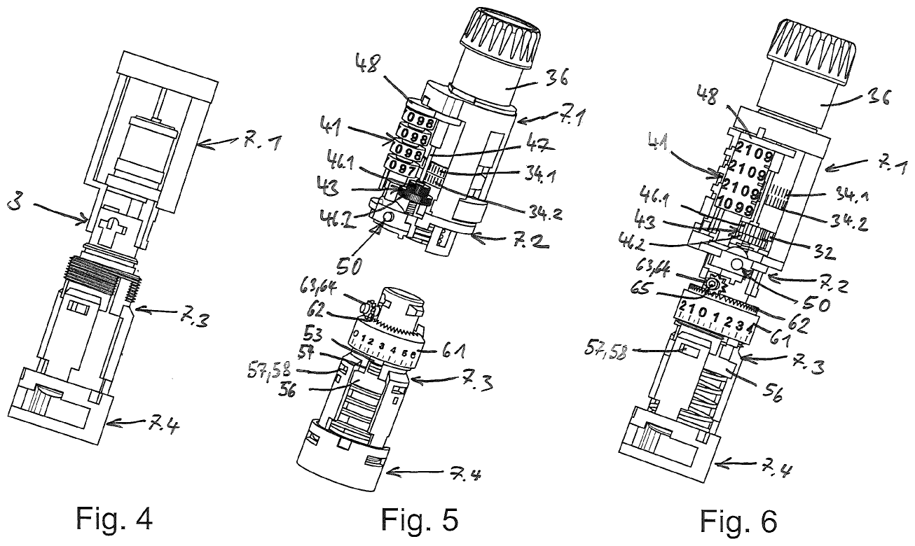

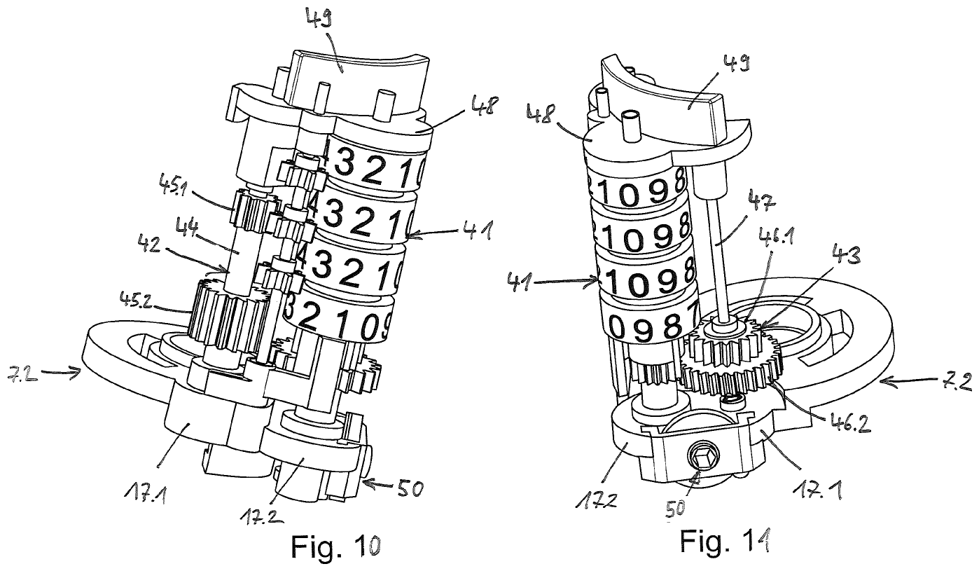

According to FIGS. 1 to 11, the air cushion pipette 1.1 has an upper part 2 which comprises a chassis 3, components 4 (e.g., a display ring) and assemblies 5 (e.g., a counter, cf. FIG. 2) as well as a tubular pipette housing 6.

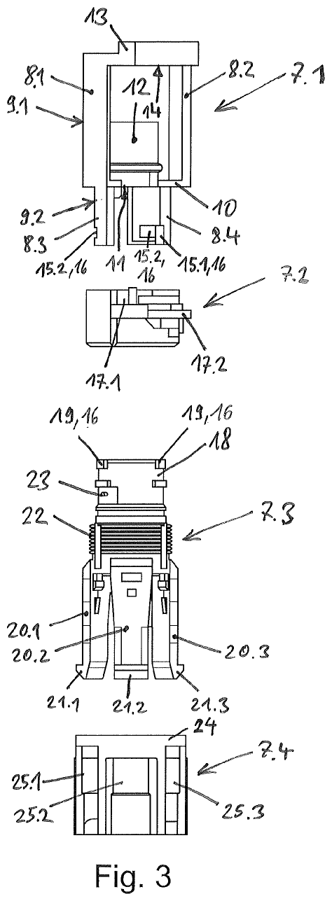

The chassis 3 comprises four tubular chassis elements 7.1, 7.2, 7.3, 7.4 which are detachably connected to one another. The chassis 3 has a first chassis element 7.1 at the top, which has an upper portion 9.1 delimited by upper hollow cylindrical segments 8.1, 8.2 of larger diameter and, at the bottom, a lower portion 9.2 delimited by lower hollow cylindrical segments 8.3, 8.4 of smaller diameter (see FIG. 3). Therebetween, an upwardly protruding dome 12 is arranged on a plate 10 having a central through-hole 11. At the top, the upper hollow cylindrical segments 8.1, 8.2 are connected to one another on one side by a circular arc-shaped crosspiece 13 which has a pocket opened downward 14.

A substantially annular second chassis element 7.2 is arranged therebelow, which can be pushed from below onto the lower portion 9.2 of the first chassis element 7.1. Grooves 15.1, 15.2 directed in the axial and in the circumferential direction of a bayonet connection 16 are configured on the inner sides of the lower portion 9.2 of the first chassis element 7.1. The second chassis element 7.2 has consoles 17.1, 17.2 protruding outward on the casing (cf. FIGS. 2, 10, 11).

A third chassis element 7.3 is arranged under the second chassis element 7.2, which has a tubular portion 18 at the top with projections 19 of the bayonet connection 16, which complement the grooves 15.1, 15.2, on the outer circumference (cf. FIG. 3). At the bottom, the third chassis element 7.2 is provided with three legs 20.1, 20.2, 20.3 protruding downward with hooks 21.1, 21.2, 21.3 at the ends. The tubular portion 18 of the third chassis element 7.3 has an external thread 22 on the outer circumference and, above it, an outwardly protruding bearing spigot 23.

The fourth chassis element 7.4, which has an annular configuration, is arranged therebelow. The fourth chassis element 7.4 has a circumferential crosspiece 24 at the top and has multiple apertures 25.1, 25.2, 25.3 therebelow in the casing.

In order to connect to the first chassis element 7.1, the second chassis element 7.2 is pushed onto the lower portion 9.2 of the first chassis element 7.1. Here, a minimum latching between the two chassis elements 7.1, 7.2 is effective.

The third chassis element 7.3 is connected to the first and second chassis element 7.1, 7.2 via the bayonet connection 16.

The fourth chassis element 7.4 is connected by being pushed onto the legs 20.1, 20.2, 20.3 of the third chassis element 7.3 until the hooks 21.1, 21.2, 21.3 engage in the apertures 25.1, 25.2, 25.3 of the fourth chassis element 7.4.

Prior to connecting the chassis elements 7.1, 7.2, 7.3, 7.4 to one another, these can be equipped with components 4 and assemblies 5.

A hollow threaded spindle 27 is screwed from below into an internal thread 26 in the dome 12 of the first chassis element 7.1. A catch 28 having outwardly protruding catch wings 29.1, 29.2 is connected to the upper end of the threaded spindle 27 for conjoint rotation. A catch sleeve 30 is pushed onto the dome 12 from above, which has axial grooves 31.1, 31.2 on the inner circumference, which receive the catch wings 29.1, 29.2. The catch sleeve 30 has a circumferential toothing 32 externally on the lower end (cf. FIG. 1).

A lower adjusting sleeve 33 is pushed onto the catch sleeve 30 from above, which has two circumferential toothings 34.1, 34.2 of different diameter on the circumference at the bottom.

A bearing shell 35 is inserted between the lower adjusting sleeve 33 and the upper portion 9.1 of the first chassis element 7.1. An upper adjusting sleeve 36 is pressed onto the lower adjusting sleeve 33 from above or is fixedly connected thereto in another way, which upper adjusting sleeve protrudes at the top with an adjusting wheel from the first chassis element 7.1.

A lifting rod 37 is introduced from below into the threaded spindle 27, which lifting rod can be slid with a bulge-like collar 39 against the underside of the threaded spindle 27 which forms an upper stop 40.

A counter 41, a transfer unit 42 and a drive gearwheel 43 can be pushed from above onto the consoles 17.1, 17.2 of the second chassis element 7.2. The transfer unit 42 is a shaft 44, on which multiple pinions 45.1, 45.2 are arranged. The drive gearwheel 43 comprises two spur gears 46.1, 46.2 having different diameters on a common shaft 47 (cf. FIGS. 2, 5-8, 10, 11).

A bearing plate 48 having a rib 49 protruding upward in the shape of a circular arc is placed at the top on the counter 41, the transfer unit 42 and the drive gearwheel 43. Moreover, apparatuses 50 for a factory calibration are assembled on the second chassis element 7.2.

When pushing the second chassis element 7.2 onto the first chassis element 7.1, the circular arc-shaped rib 51 engages in the pocket 14. Furthermore, the pinions 45.1 and 45.2 on the transfer unit 42 come into engagement with the toothings 34.1 and 32 if the adjusting sleeves 33, 36 are arranged in their highest position. If they are displaced to their lowest position, the pinion 45.2 comes into engagement with the toothings 34.2 and 32 and the pinion 45.1 is out of engagement. This produces different gear multiplications between the adjusting sleeves 33, 36 and the catch sleeve 30.

A lower stop 51 of an overstroke system 52 is inserted into the third chassis element 7.3 from below. The lower stop 51 has outwardly protruding projections 53 which are inserted into grooves 54 on the inner circumference of the third chassis element 7.3. Furthermore, an overstroke spring 55 is inserted from below into the lower stop 51. Finally, a disk 56 is pressed from below against the overstroke spring 55, which disk has latching noses 57 protruding from the circumference, which latch into latching holes 58 on the inner circumference of the third chassis element 7.3. The disk 56 is a bearing for the overstroke spring 52 (cf. FIGS. 1, 5, 6).

The lower stop 51 and the disk 56 each have a central through-hole 59, 60 for inserting the lifting rod 37.

A display ring 61 having a circumferential toothing 62 on the upper edge is screwed onto the external thread 22 of the third chassis element 7.3. The upper edge of the display ring 61 is inclined, wherein its inclination corresponds to the pitch of the external thread 22 on the third chassis element 7.3. A drive element 63 of a crown toothing 64 is pushed onto the bearing spigot 23, which crown toothing meshes with the toothing 62 on the upper edge of the display ring 61. The drive element 63 has an internal hexagon 65 for affixing a tool for a customer calibration.

Prior to connecting the third chassis element 7.3 to the first and the second chassis element 7.1, 7.2, a bayonet spring 66, which is supported at the bottom on an inwardly protruding shoulder 67 of the third chassis element 7.3 and, at the top, presses against an inwardly protruding projection 68 of the second chassis element 7.2, is inserted from above into the third chassis element 7.3. The bayonet connection is secured in a connecting position by the bayonet spring 66.

The fourth chassis element 7.4 is connected to the third chassis element by snapping it onto the hooks on the legs of said third chassis element.

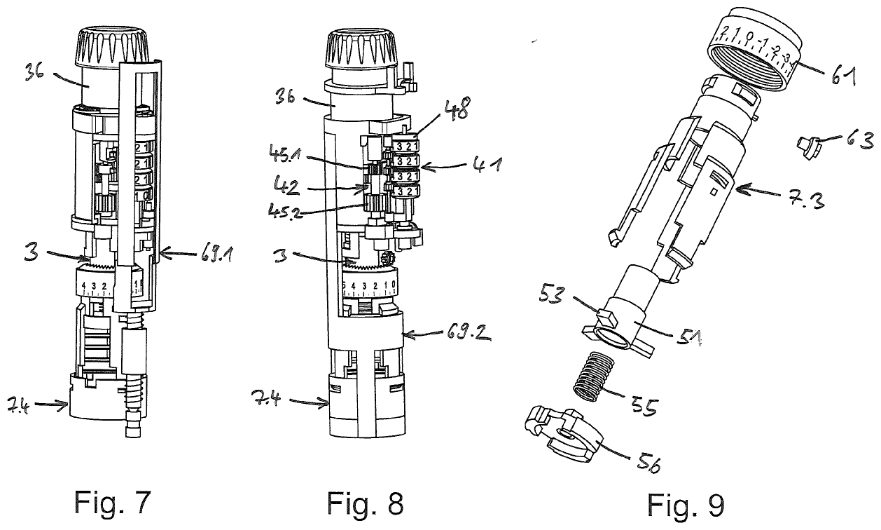

Finally, ejection apparatuses 69.1, 69.2 are placed from outside onto the preassembled chassis 3, two embodiments of which are shown in FIGS. 7 and 8.

The joined-together chassis 3 with the preassembled components 4 and assemblies 5 is pushed into the pipette housing 6 from above. The pipette housing 6 has three protruding projections 70.1, 70.2, 70.3 in the lower region on the inner circumference. The chassis 3 is pushed into the pipette housing 6 until the underside of the circumferential crosspiece of the fourth chassis element 7.4 is supported on the top of the projections 70 and the hooks 21.1, 21.2, 21.3 of the third chassis element 7.3 snap under the projections of the pipette housing. Finally, in order to secure the arrangement from below, a biasing spring 71 is inserted into the fourth chassis element 7.4, which latches on the upper end with projections in the third chassis element and supports the legs 20.1, 20.2, 20.3 internally. The biasing spring 71 additionally serves to establish a connection with a lower part of the pipette.

For the connection with a lower part of the pipette 1.1, the fourth chassis element 7.4 (lower edge coupling frame) has an inwardly protruding, circumferential shoulder 72 on the lower edge.

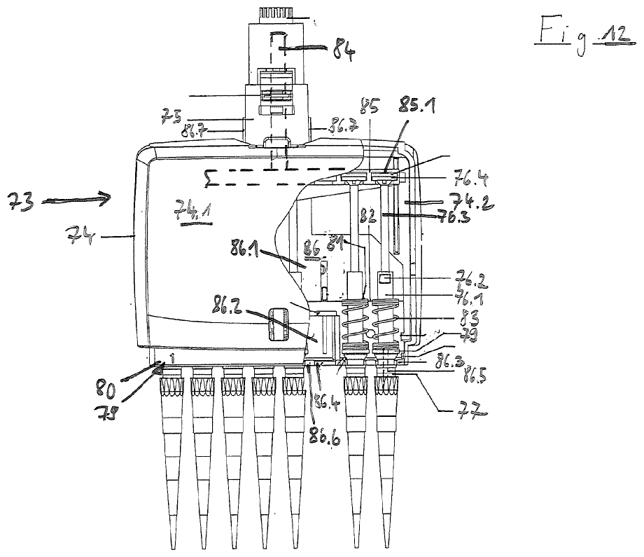

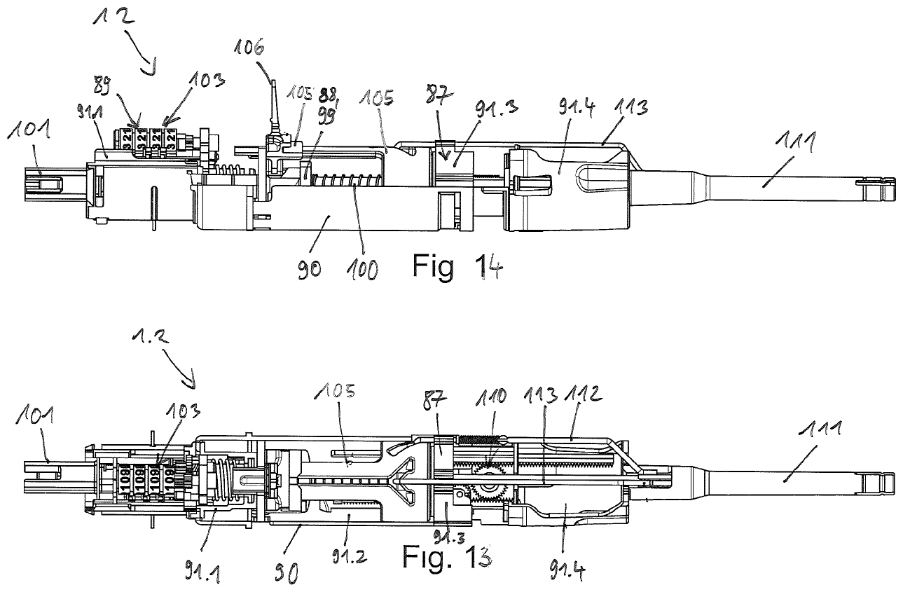

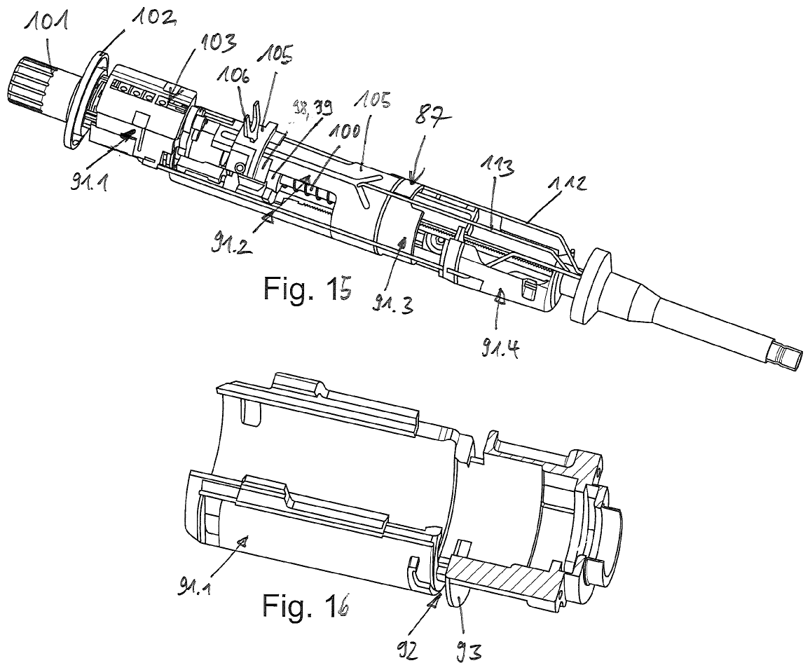

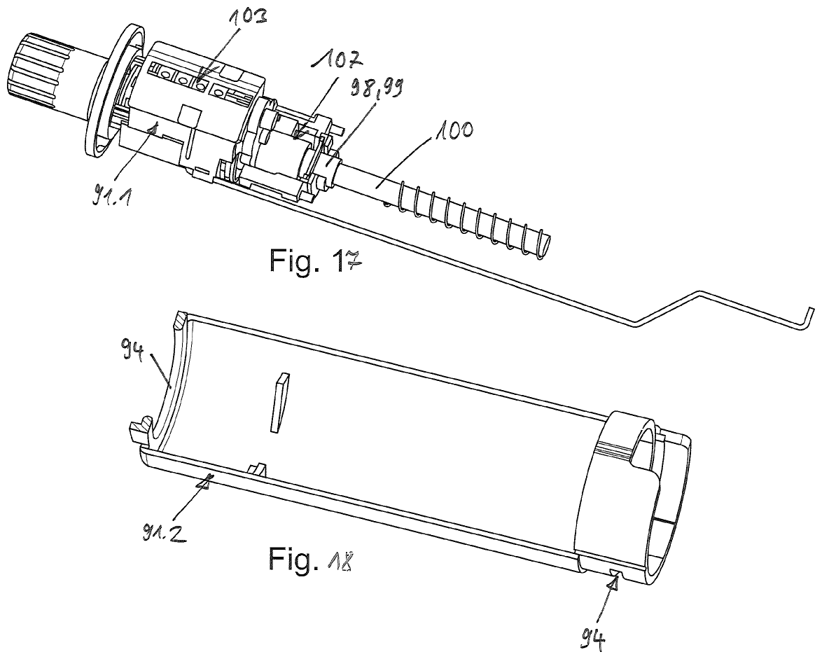

According to FIG. 12, the lower part 73 of the pipette has a box-like lower part chassis 74 which is formed from a front and a rear housing shell 74.1, 74.2 which are joined together in a vertical plane. The lower part 73 has a tubular connecting spigot 75 protruding upward from the upper edge of the lower part chassis 74. The connecting spigot 75 is connected in one piece to one of the two housing shells 74.1, 74.2.

In the lower part 73, eight parallel piston-cylinder apparatuses 76 are arranged in a row. Each piston-cylinder apparatus 76 has a cylinder 76.1, into which a piston 76.2, which is connected via a piston rod 76.3 to a piston disk 76.4, plunges.

At the bottom, each cylinder 76.1 is connected in one piece to a downwardly protruding spigot 77 for mounting a pipette tip on a dosing component 78. Each spigot 77 has a through-bore which is connected at the top to the internal space of the cylinder 76.1, in which the piston 76.2 can be displaced, and opens out at the bottom in an opening in the lower end of the spigot 77.

Each dosing component 78 has a circumferential projection 79 between the spigot 77 and the cylinder 76.1.

The circumferential projections 79 of the dosing components 78 are supported on the upper edges of through-holes 79 in a horizontal lower wall 80 of the lower part 73. The cylinders 76.1 are guided further up through other through-holes 81 of a horizontal support plate 82 of the lower part 73.

A spring element 83 which is embodied as a helical spring, which is supported at the bottom on the circumferential projection 79 and at the top on the lower side of the support plate 82, is guided on each cylinder 76.1.

A drive rod 84 is inserted in the connecting spigots 75, which drive rod is connected at the bottom to a cross-member 85, which has receptacles 85.1, into which the piston disks 76.4 are inserted.

The lower part 73 furthermore comprises a two-part ejector 86 which has a vertical plate-shaped ejector part 86.1, 86.2 on the lower edge, a two-part horizontal stop 86.3, 86.4 having through-openings 86.5, 86.6 open towards the front edge and an actuating element 86.7 protruding upward from the upper edge of the plate-shaped ejector part 86.1.

Details of the lower part 73 and of the two-part ejector 86 and their coupling to a pipette can be inferred from EP 2 735 369 A1, in particular paragraphs 55 and 62 to 83 as well as FIGS. 1 to 10. An alternative embodiment, which can likewise be used in the context of the present invention, is described in particular in paragraphs 91 to 98 and FIGS. 11 to 16 of the aforementioned patent. In this regard, reference is made to EP 2 735 369 A1, the contents of which are hereby incorporated into this application.

The lower part 73 can be connected to the upper part 2 of the pipette 1.1 by inserting the connecting spigot 75 into the fourth chassis element 7.4.

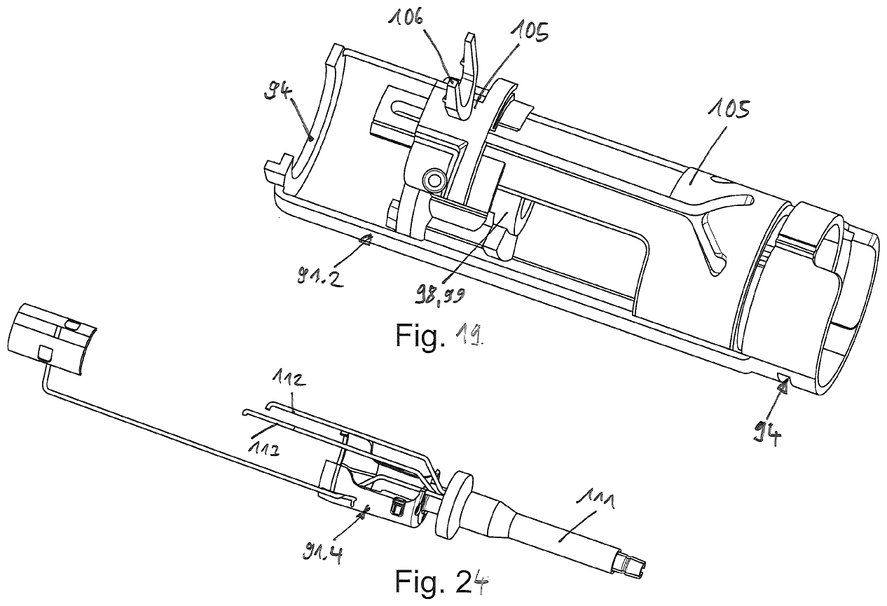

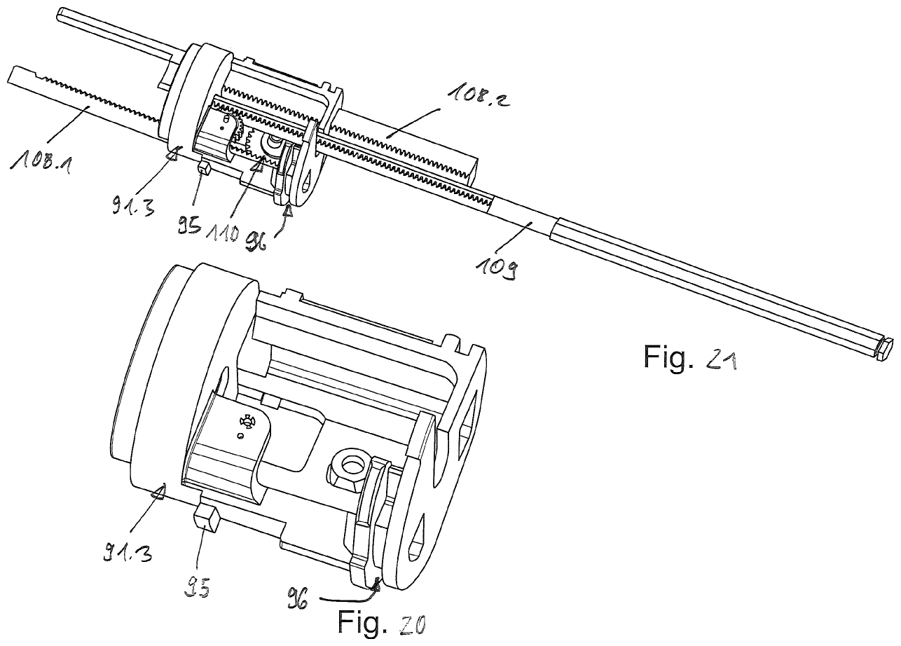

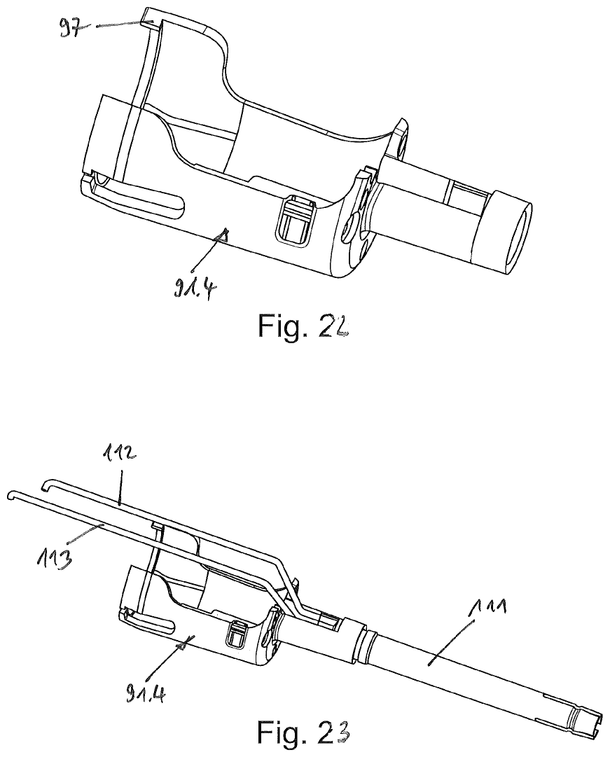

According to FIGS. 13 to 24, a positive displacement pipette 1.2 has a chassis 87 with components 88 and assemblies 89 connected thereto and a pipette housing 90 enclosing the chassis 87 and the components 88 and assemblies 89.

The chassis 87 comprises four tubular chassis elements 91.1, 91.2, 91.3, 91.4.

The chassis 87 has a first chassis element 91.1 at the top, which has a circumferential groove 92 on the outer circumference and, in addition, a circumferential, outwardly protruding collar 93 for the connection to a second chassis element 91.1.

The second chassis element 91.2 has, on the upper end, an inwardly protruding flange 94 for connecting to the groove 92 and collar 93 of the first chassis element 91.1. The first chassis element 91.1 and the second chassis element 91.2 can be detachably connected to one another by screwing the flange 94 into the groove 92.

The second chassis element 91.2 has, on the lower end, a slot 94 for a rotary connection to the third chassis element 91.3 which has outwardly protruding wings 95 for connecting to the slot 94 on the casing.

The third chassis element 91.3 has slots 96 on the lower end on the circumference and the fourth chassis element 91.4 has projections 97 which complement these slots for a rotary connection of the third chassis element 91.3 and fourth chassis element 91.4.

The chassis elements 91.1 to 91.4 can be equipped separately from one another with components 88 and assemblies 89. The first chassis element 91.1 can be equipped with an apparatus for adjusting the pipetting volume 98. This comprises a spindle nut 99 which can be connected to a flange and a key surface on the lower end of the first chassis element 91.1. A guide tube 100 protrudes downward from the spindle nut 99. A threaded spindle is screwed into the spindle nut 99, which threaded spindle is provided at the top with an adjusting knob 101 which protrudes from the upper end of the first chassis element 91.1. An upper housing cover 102 is fixed on the upper end of the first chassis element.

A counter 103, which is coupled to the threaded spindle via a gear mechanism, is assembled on the open side of the first chassis element.

A transmission mechanism 104 and a rotating sleeve 105 are inserted into the second chassis element 91.2. Furthermore, the transmission mechanism is connected to an actuating element 106. The second chassis element 31.2 comprises an apparatus for switching between an upward movement and a downward movement of a piston lifting rod.

Two toothed rods 108.1, 108.2, a piston lifting rod 109 having a toothing on the upper end and a gear drive 110 are mounted in the third chassis element 91.3.

Finally, a spigot 111 as well as a locking sleeve 112 and a piston ejection rod 113 are assembled in the fourth chassis element 91.4.

The preassembled assemblies are connected to one another by connecting the chassis elements 91.1 to 91.4 and the chassis 87 is installed in the pipette housing 90.

### LIST OF REFERENCE NUMERALS

1.1 Air cushion pipette
2 Upper part
3 Chassis
4 Component
5 Assembly
6 Pipette housing
7.1, 7.2, 7.3, 7.4 Chassis element
8.1, 8.2 Upper hollow cylindrical segment
8.3, 8.4 Lower hollow cylindrical segment
9.1 Upper portion
9.2 Lower portion
10 Plate
11 Through-hole
12 Dome
13 Crosspiece
14 Pocket
15.1, 15.2 Grooves
16 Bayonet connection
17.1, 17.2 Consoles
18 Tubular portion
19.1, 19.2 Projections
20.1, 20.2, 20.3 Legs
21.1, 21.2, 21.3 Hook
22 External thread
23 Bearing spigot
24 Crosspiece
25.1, 25.2, 25.3 Aperture
26 Internal thread
27 Threaded spindle
28 Catch
29.1, 29.2 Catch wing
30 Catch sleeve
31.1, 31.2 Axial grooves
32 Toothing
33 Lower adjusting sleeve
34.1, 34.2 Toothing
35 Bearing shell
36 Upper adjusting sleeve
37 Lifting rod
39 Collar
40 Upper stop
41 Counter
42 Transfer unit
43 Drive gearwheel
44 Shaft
45.1, 45.2 Pinion
46.1, 46.2 Spur gear
47 Shaft
48 Bearing plate
49 Rib
50 Apparatus for a factory calibration
51 Lower stop
52 Overstroke system
53 Projection
54 Groove
55 Overstroke spring
56 Disk
57.1, 57.2, 57.3 Latching lugs
58.1, 58.2, 58.3 Latching holes
59, 60 Through-holes
61 Display ring
62 Toothing
63 Drive element
64 Crown toothing
65 Internal hexagon
66 Bayonet spring
67 Shoulder
68 Projection
69.1, 69.2 Ejection apparatus
70 Projections
71 Biasing spring
72 Shoulder
73 Lower part
74 Lower part chassis
74.1, 74.2 Housing shell
75 Connecting spigot
76 Piston-cylinder apparatus
76.1 Cylinder
76.2 Piston
76.3 Piston rod
76.4 Piston disk
77 Spigot
78 Dosing component
79 Circumferential projection
80 Lower wall
81 Through-hole
82 Support plate
83 Spring element
84 Drive rod
85 Cross-member
85.1 Receptacle
86 Ejector
86.1, 86.2 Plate-shaped ejector part
86.3, 86.4 Horizontal stop
86.5, 86.6 Through-opening
86.7 Actuating element
87 Chassis
88 Component
89 Assembly
90 Pipette housing
91.1, 91.2, 91.3, 91.4 Tubular chassis element
92 Groove
93 Collar
94 Flange
95 Wing
96 Slot
97 Projection
98 Apparatus for adjusting the pipetting volume
99 Spindle nut
100 Guide tube
101 Adjusting knob
102 Upper housing cover
103 Counter
104 Transmission mechanism
105 Rotating sleeve
106 Actuating element
108.1, 108.2 Toothed rod
109 Piston lifting rod
110 Gear drive
111 Spigot
112 Locking sleeve
113 Piston ejection rod

1. A pipette for use with a pipette tip, comprising:
an chassis extending along a chassis axis;
an apparatus connected to the chassis and configured to detachably hold at least one pipette tip;
a drive apparatus coupled to the chassis and configured to displace a displacement element to suck liquid specimens into the pipette tip and eject the specimens from the pipette tip;
a tubular pipette housing extending along a housing axis and configured to surround and connect to the chassis, wherein the chassis axis extends in a same direction as the housing axis;
wherein the chassis comprises a plurality of chassis elements behind one another and connected to one another, and
wherein the apparatus configured to detachably hold at least one pipette tip and the drive apparatus are configured to connect to at least one of the plurality of chassis elements.

2. The pipette according to claim 1, wherein each of the plurality of chassis elements are tubular.

3. The pipette according to claim 1, wherein at least one of:
one or more components of the drive apparatus for displacing a displacement element are connected to at least one chassis element;
at least one component of a display apparatus configured for displaying an adjusted pipetting volume is connected to at least one of the plurality of chassis elements;
at least one component of an ejection apparatus configured for ejecting at least one pipette tip is connected to at least one of the plurality of chassis elements;
the components of an apparatus configured to detachably hold at least one pipette tip are connected to at least one of the plurality of chassis elements; and
at least one component of an apparatus configured to detachably hold the plurality of chassis elements in the pipette housing is connected to at least one of the plurality of chassis elements.

4. The pipette according to claim 3, further comprising at least one of:
a first assembly comprising a chassis element and at least one component of the drive apparatus;
a second assembly comprising a chassis element and at least one component of the display apparatus;
a third assembly comprising a chassis element and at least one component of the ejection apparatus;
a fourth assembly comprising a chassis element and at least one component of the apparatus for detachably holding at least one pipette tip; and
a fifth assembly comprising a chassis element and at least one component of the apparatus for detachably holding the plurality of chassis elements in the pipette housing.

5. The pipette according to claim 1, further including at least one of:
the drive apparatus comprises a first subassembly which is connected to at least one of the plurality of chassis elements;
a display apparatus comprises a second subassembly which is connected to at least one of the plurality of chassis elements;
an ejection apparatus comprises a third subassembly connected to at least one of the plurality of chassis elements;
the apparatus configured to detachably hold at least one pipette tip comprises a fourth subassembly connected to at least one of the plurality of chassis elements; and
an apparatus configured to detachably hold the plurality of chassis elements in the pipette housing and further comprising at least one fifth subassembly connected to at least one of the plurality of chassis elements.

6. The pipette according to claim 1, further comprising at least one of:
the drive apparatus is configured to connect to a first chassis element;
a display apparatus is configured to connect to a second chassis element;
the drive apparatus is configured to connect to a third chassis element;
the apparatus configured to detachably hold at least one pipette tip is configured to connect to a fourth chassis element; and
an apparatus configured to detachably hold the plurality of chassis elements in the pipette housing is configured to connect to the fourth chassis element.

7. The pipette according to claim 1, wherein at least one of: (i) components of the drive apparatus are connected to a first chassis element; and (ii) components of a display apparatus are connected to the first chassis element.

8. The pipette according to claim 7, wherein at least one of: (i) components of the drive apparatus are configured to couple to a second chassis element; and (ii) components of an ejection apparatus are configured to connect to a second chassis element.

9. The pipette according to claim 8, wherein at least one of: (i) components of the drive apparatus are configured to connect to a third chassis element; and (ii) components of the ejection device are configured to connect to a fourth chassis element.

10. The pipette according to claim 9, wherein the first chassis element is positioned above the second chassis element, wherein the second chassis element is positioned above the third chassis element, and wherein the third chassis element is positioned above the fourth chassis element.

11. The pipette according to claim 1, wherein the drive apparatus comprises:
a threaded spindle configured to engage in an internal thread of a first chassis element, wherein the threaded spindle is configured to be adjusted in a longitudinal direction of the first chassis element;
an adjusting sleeve rotatably mounted in the first chassis element and configured to connect to the threaded spindle, wherein the adjusting sleeve is configured to rotate conjointly with the threaded spindle, and wherein the adjusting sleeve and the threaded spindle are configured to be displaced in the longitudinal direction relative to one another;
an adjusting knob configured to protrude upward from the first chassis element; and
a lifting rod configured to traverse the threaded spindle and extend in the longitudinal direction, wherein the lifting rod and the at least one projection are configured to be displaced to contact a first stop on an underside of the threaded spindle and forming a drive element below a projection and protruding from the first chassis element with an operating knob on an upper end.

12. The pipette according to claim 11, further comprising a second chassis element coupled to a lower end of the first chassis element and a counter coupled to a holding apparatus on a casing of the second chassis element and of the first chassis element.

13. The pipette according to claim 12, further comprising:
a third chassis element connected to the lower end of at least one of the first chassis element and the second chassis element;
an overstroke system defining a passage arranged inside the third chassis element, wherein a lifting rod extends downward through the passage, wherein during a downward displacement, the lifting rod, after the projection hits a second stop on a top of the overstroke system, is configured to be displaced downward against a force of an overstroke spring.

14. The pipette according to claim 13, further comprising a fourth chassis element configured as a tubular coupling element and comprising a lower part comprising a connecting spigot inserted into the tubular coupling element, wherein the lower part comprises at least one displacement element positioned in a displacement chamber and a hollow spigot connected to the displacement chamber and configured to detachably hold a pipette tip.

15. The pipette according to claim 14, wherein the lower part comprises a drive rod coupled to the lower end of the lifting rod in the connecting spigot and further configured to couple to the tubular coupling element, wherein the drive rod is configured to connect to at least one piston which is displaceably arranged in a cylinder, and wherein the cylinder is arranged in the lower part and is configured to connect to a spigot configured to detachably hold the pipette tip protruding from the lower part.

16. The pipette according to claim 15, further comprising multiple cylinders held parallel to one another in a box-like lower part chassis, wherein the box-like lower part chassis is configured to connect at a top to the spigot to form a lower part housing.

17. The pipette according to claim 7, wherein the first chassis element comprises:
an adjusting apparatus with an adjusting knob configured to adjust a dosing volume, wherein the adjusting knob is configured to protrude upward from the first chassis element and is rotatably mounted on the first chassis element; and
a counter coupled to the adjusting apparatus and configured for adjusting the adjusted dosing volume.

18. The pipette according to claim 17, further comprising a second chassis element configured to rotatably support a rotating sleeve on a casing and an actuating element arranged on the second chassis element that is configured to execute a dosing stroke and eject a pipette tip from a spigot.

19. The pipette according to claim 18, further comprising a switching apparatus connected to the second chassis element, wherein the switching apparatus is coupled to the actuating element and configured to displace a lifting rod to displace a tip piston in different directions during successive displacements of the actuating element by a downward stroke.

20. The pipette according to claim 19, further comprising:
a third chassis element configured to connect to a toothed rod;
a lifting rod and a gear mechanism configured to couple the toothed rod and the piston lifting rod;
guides for a piston ejector; and
an apparatus for adjusting a display sleeve.

21. The pipette according to claim 20, further comprising an ejection apparatus configured to eject pipette tips from the spigot and be guided on one of: (i) the first chassis element; and (ii) a fourth chassis element.

22. The pipette according to claim 1, wherein adjacent chassis elements of the plurality of chassis elements are connected to one another.

23. The pipette according to claim 22, wherein adjacent chassis elements comprise positioning elements configured to hold the adjacent chassis elements in position relative to one another, wherein the positioning elements comprise at least one pair of magnetic components.

24. The pipette according to claim 1, wherein at least one of the plurality of chassis elements comprises a position surface configured to engage a test gage.

25. The pipette according to claim 1, wherein the pipette housing is connected to a lower end of the chassis.
